(19) United States
(12) Patent Application Publication
(10) Pub. No.: US 2002/0049124 A1
(43) Pub. Date: Apr. 25, 2002

(54) Finger roller for agricultural machines

(75) Inventor: Sebastian Jager, Hannover (DE)

Correspondence Address: ROBERT W. BECKER & ASSOCIATES, Suite B, 11896 N. Highway 87059, Tijeras, NM, 87059, US

(73) Assignee: ARTEMIS Kautschuk-Uno Kunststofftechnik GmbH & Cie., Hannover (DE)

(21) Appl. No.: 09/785,052

(22) Filed: Feb. 15, 2001

(30) Foreign Application Priority Data
Feb. 15, 2000 (DE) 200 02 732.8

(51) Int. Cl. F16C 13/00

(52) U.S. Cl. 492/40

(57) ABSTRACT

A finger roller is provided for agricultural machines, and includes a plurality of elastically deformable finger disks that are disposed on a driven shaft closely adjacent to one another. The hub of each finger disk has a plurality of elastically deformable fingers projecting therefrom. Each hub has at least one insert for increasing its axial rigidity, and/or it is made of a material that is harder than its fingers.

### BACKGROUND OF THE INVENTION

The present invention relates to a finger roller for agricultural machines, with the roller having a plurality of elastically deformable finger disks that are disposed on a shaft closely adjacent to one another, with the hub of each finger disk being provided with a plurality of elastically deformable fingers that are distributed over and project from the hub. In this connection, it is to be understood that the dimensions of the finger disks must be such that the disks are seated on their shaft in a manner practically free of play in order to preclude relative movements between the shaft and the hub.

The present invention is preferably directed to such finger rollers where the hubs have a large axial extension relative to the width or axial extension of their fingers. Such a dimension also has the advantage that when several rollers are disposed parallel to one another, the fingers of one roller can engage between the fingers of the adjacent roller.

Rollers embodied in this fashion are used with turnip and potato diggers, vegetable harvesting machines, and the like, and also for stone or rock collectors, in order with the aid thereof to be able to clean the collected material or harvested vegetables, to sort them, to sift them, and to remove any earth from the material.

Due to the fact that the finger disks on the whole comprise an elastomeric material, elastic deformations of the hubs can occur as the individual finger disks are placed upon the shaft, thereby reducing the axial extension (width) of the hubs. Although such a deformation is in itself not a drawback, nonetheless it was observed that after placement of the hubs on the shaft, the hubs do not return to their desired width, which leads to frictional contact between the hub and the shaft.

It is an object of the present invention to improve a finger roller of the aforementioned general type, and in particular the finger disk thereof, in such a way that the aforementioned, undesired deformations do not occur, or at most can occur to only a considerably reduced extent. At the same time, it is also an object of the present invention to simplify assembly for those finger rollers where successive finger disks have different constructions, and a correct sequence of the finger disk is critical.

### BRIEF DESCRIPTION OF THE DRAWING

These and other objects and advantages of the present invention will appear more clearly from the following specification in conjunction with the accompanying schematic drawing, in which:

FIG. 1 is a partial cross-sectional view through a finger roller for agricultural machines of the aforementioned types;

FIG. 2 shows a finger roller with the fingers being indicated, and also indicates the fingers of an adjacent finger roller, the fingers of which extend between the fingers of the first mentioned roller;

FIG. 3 is a partial radial cross-sectional view through a finger disk for the production of finger rollers; and

FIG. 4 is a partial cross-sectional view through the hub of a finger disk where one finger is merely indicated.

### SUMMARY OF THE INVENTION

To realize the inventive objects, the hub of the finger disks of the present invention are provided with one or more insert means that increase the axial rigidity of the hubs, and/or the hubs are made of a material that is harder than the material of their fingers.

The increased axial rigidity of the hubs can be achieved by an appropriate selection of the material, but for example also with certain additives, such as an increased sulfur additive with rubber, and/or by special insert means as reinforcing inserts, for example in the form of textile inserts. However, particularly advantageous are rigid pins that are shoved into axial bores of the hubs accompanied by a slight elastic expansion of these bores; the pins preferably have a length that practically corresponds to the axial extension or width of the hub of the finger disks.

Such pins also offer the possibility of simplifying assembly of the individual finger disks (where the finger disks differ from one another) by providing a specific shape and/or color to the pins, and in particular to their outwardly visible heads. Under these conditions, a person undertaking assembly can readily recognize the nature of the individual finger disks, and can undertake an appropriate sequence of the finger disks.

Further specific features of the present invention will be described in detail subsequently.

### DESCRIPTION OF PREFERRED EMBODIMENTS

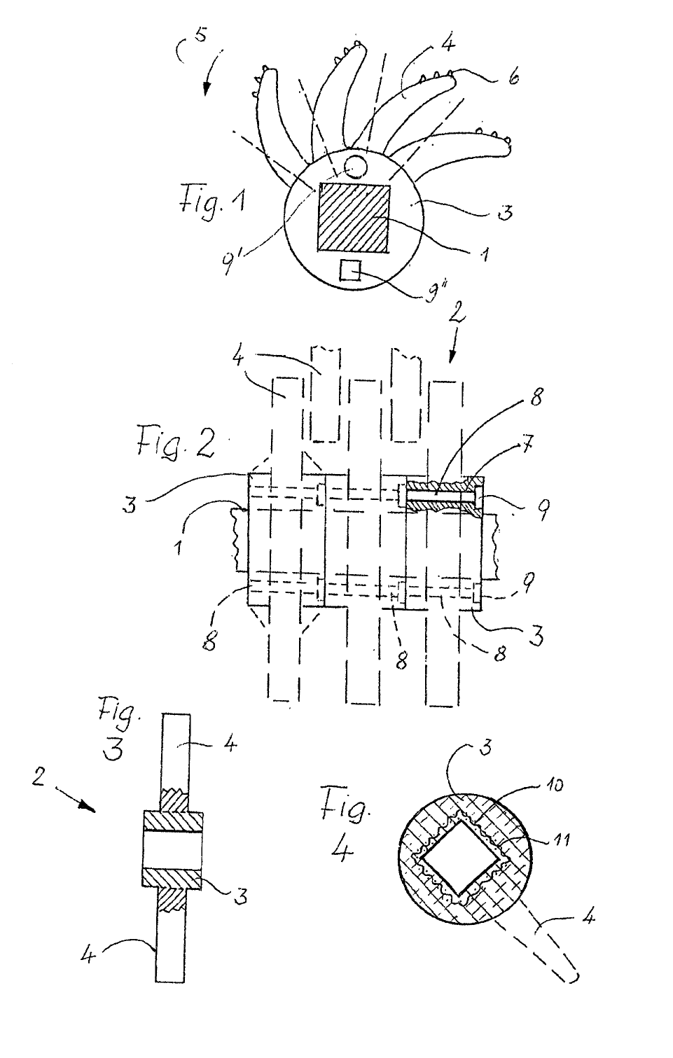

Referring now to the drawing in detail, the finger roller illustrated in FIG. 1 essentially comprises a rotatably mounted, driven shaft 1 on which finger disks 2 are disposed one after the other. The finger disks 2 comprise a hub 3 and a plurality of fingers 4 that are uniformly distributed over the periphery of the hub. As shown in FIG. 1, the fingers 4 can be curved, and in the illustrated embodiment are curved counter to the direction of rotation 5 of the finger roller. In contrast, in the embodiment illustrated in FIG. 4 the fingers 4 project radially; other configurations are, of course, also possible. In order to provide a fixed mounting for the finger disks 2, the shaft 1 is embodied as a square or four-cornered shaft.

The finger disks 2 are in particular embodied as injection molded articles. Preferred materials for the finger disks include a polymer, for example on a rubber, polyurethane, elastomer or thermoplastic base. In any case, it must be ensured that the fingers 4 are elastically deformable, and can be deflected under the effect of the material that is to be handled. An increased effect is furthermore provided if a forward facing side of the fingers, as viewed in the direction of rotation, is provided in the region of the free end of the finger with roughened portions, for example in the form of the small projections 6 illustrated in FIG. 1.

It is to be understood that the finger roller, which is composed of the individual finger disks 2, is suitable to withstand great mechanical stresses only if the finger disks 2 are disposed on the shaft 1 in a manner free of play. In order during placement of the finger disk 2 upon the shaft 1 to prevent undesired deformations of the hub 3, which after assembly of the finger disk 2 generally cannot be reversed, it is proposed pursuant to the present invention, as shown in FIGS. 1 and 2, to provide the hubs 3 with a plurality of, preferably two, axially extending, diametrically opposed, bores 7 that serve for receiving rigid pins 8 that have a widened head 9. These pins practically extend over the entire width of the pertaining hub 3, but do not project there beyond. As can also be seen from FIG. 2, the pins 8 of adjacent or successive finger disks 2 are flush or aligned with one another and can thus influence one another.

The pins 8 are considerably harder than the material for the hub 3 with its fingers 4, and after the hub 3 and fingers 4 are formed, the pins 8 are driven into the bores 7 and can, for example, comprise an industrial thermoplastic material (PA, PP, PE, and the like).

When the thus equipped hubs 3, together with their fingers 4, are placed one after the other on the shaft 1, a disadvantageous reduction in width of the hubs 3 cannot occur even if the hubs 3 are placed upon the shaft 1 with a radial preload.

The pins 8 have the additional advantage that they can be provided with differently shaped heads 9, such as, for example, a round head 9′ or a square head 9″ (see FIG. 1). In this way, the assembly person or manufacturer of the finger rollers can readily complete or carry out specific sequences of differently provided finger rollers since each type of finger disk has a specific characteristic.

In the embodiment illustrated in FIG. 3, the finger disks 2 also have a one-piece construction, but the hubs 3 are made of a material that is considerably harder. Differences in hardness of about 10-25 Shore Grade A can in this connection be advantageous.

In the embodiment illustrated in FIG. 4, axial reinforcement of the finger disk 2 is achieved by an annular reinforcing insert 10 that surrounds the central opening of the hub 3 and is in the form of a layer 11, for example a woven textile ply, that is located in the inside of the hub 3.

It should be noted that although any number of fingers 4 could be provided, in practice more than twelve fingers are advantageous. Furthermore, finger disks having an even number of fingers could be followed by a finger disk having an uneven number of fingers, whereby the differently characterized pins 8 are then advantageous in order to easily ensure the desired sequence of finger disks.

This specification incorporates by reference the disclosure of German priority document 200 02 732.8 of Feb. 15, 2000.

The present invention is, of course, in no way restricted to the specific disclosure of the specification and drawing, but also encompasses any modifications with the scope of the appended claims.

What I claim is:

1. A finger roller for agricultural machines, comprising:
a driven shaft;
a plurality of finger disks of elastically deformable material, wherein said finger disks are disposed on said shaft closely adjacent to one another, and wherein each of said finger disks has a hub;
a plurality of elastically deformable fingers distributed over and projecting from each of said hubs, wherein said fingers merge integrally with said hub; and
wherein each of said hubs is selectively provided with at least one of:
at least one insert means for increasing an axial rigidity of said hub, and a material that is harder than that of said fingers.

2. A finger roller according to claim 1, wherein said insert means are rigid pins that extend through openings of said hub, wherein said openings correspond substantially in shape to the shape of said pins.

3. A finger roller according to claim 2, wherein each of said pins has a widened head.

4. A finger roller according to claim 2, wherein ends of said pins are provided with at least one of a different shape and a different color.

5. A finger roller according to claim 2, wherein each of said pins corresponds to an axial dimension of said hub.

6. A finger roller according to claim 2, wherein said pins are held in said hub with elastic prestress.

7. A finger roller according to claim 5, wherein pins of successive finger disks are aligned with one another.

8. A finger roller according to claim 2, wherein each of said hubs is provided with two of said pins, which are disposed diametrically opposite one another.

9. A finger roller according to claim 1, wherein at least portions of said hub are made of a material that is considerably harder than the material of said fingers.

10. A finger roller according to claim 9, wherein the difference in hardness is approximately 10-25 Shore Grade A.

11. A finger roller according to claim 1, wherein said hub has a central opening for receiving said shaft of said roller, and wherein said insert means is a reinforcing insert that surrounds said central opening of said hub.

12. A finger roller according to claim 11, wherein said reinforcing insert is in the form of a woven textile ply.

13. A finger roller according to claim 11, wherein said at least one reinforcing insert is disposed on or in the vicinity of an inner side of said hub facing said shaft.

14. A finger disk suitable for mounting on a shaft to help form the finger roller of claim 1.
